(19) United States
(12) Patent Application Publication
(10) Pub. No.: US 2025/0145436 A1
(43) Pub. Date: May 8, 2025

(54) STACKER CRANE

(71) Applicant: DAIFUKU CO., LTD., Osaka (JP)

(72) Inventors: Hiroshi NAKAMURA, Shiga (JP); Kento KINO, Shiga (JP)

(73) Assignee: DAIFUKU CO., LTD., Osaka (JP)

(21) Appl. No.: 18/907,645

(22) Filed: Oct. 7, 2024

(30) Foreign Application Priority Data
Nov. 2, 2023 (JP) 2023-188854

(51) Int. Cl. B66F 9/24; B66F 9/07

(52) U.S. Cl. CPC B66F 9/24; B66F 9/07

(57) ABSTRACT

To achieve a stacker crane in which a regeneration resistor is disposed in an appropriate position. The stacker crane (1) includes a carrier section (10), masts (20) provided upright on the carrier section, and a carriage (30) capable of being raised and lowered with respect to the masts, the masts each having at least a first portion (21) and a second portion (22) disposed on the first portion, a control machine being fixed to the first portion, a regeneration resistor being fixed to the second portion.

This Nonprovisional application claims priority under 35 U.S.C. § 119 on Patent Application No. 2023-188854 filed in Japan on Nov. 2, 2023, the entire contents of which are hereby incorporated by reference.

### TECHNICAL FIELD

The present invention relates to a stacker crane.

### BACKGROUND ART

Patent Literature 1 discloses a stacker crane that enables reduction in a burden of on-site work during assembly. In the stacker crane, a pair of masts are provided in the front and rear of a traveling carrier, and a carriage is raised and lowered along the masts. The pair of masts each have a first portion fixed to the traveling carrier and a second portion coupled to the first portion, and separating the first portion and the second portion from other each can facilitate transportation of the stacker crane before installation.

### CITATION LIST

### Patent Literature

### Patent Literature 1

Japanese Patent Application Publication, Tokukai, No. 2010-247923

### SUMMARY OF INVENTION

### Technical Problem

In some cases, in stacker cranes, traveling motors or raising and lowering motors thereof are controlled to be caused to carry out regeneration operation. In this case, the stacker cranes may be provided with regeneration resistors configured to consume a regenerative energy caused by the regeneration operation carried out by the traveling motors or the like. The arrangement of such a regeneration resistor in the stacker crane has not been sufficiently examined until now.

It is an object of an aspect of the present invention to achieve a stacker crane in which a regeneration resistor is disposed in an appropriate position.

### Solution to Problem

In order to solve the foregoing problem, a stacker crane in accordance with an aspect of the present invention includes: a carrier section configured to travel on a track; a mast provided upright on the carrier section; a carriage provided so as to be capable of being raised and lowered with respect to the mast; a raising and lowering motor configured to raise and lower the carriage; a traveling motor configured to cause the carrier section to travel; a control machine configured to drive at least one of the raising and lowering motor and the traveling motor; and a regeneration resistor configured to consume regenerative energy caused when at least one of the raising and lowering motor and the traveling motor carries out regeneration operation, the mast having at least a first portion and a second portion disposed on the first portion and coupled to the first portion, the control machine being fixed to the first portion, the regeneration resistor being fixed to the second portion.

### Advantageous Effects of Invention

According to an aspect of the present

invention, it is possible to achieve a stacker crane in which a regeneration resistor is disposed in an appropriate position.

### BRIEF DESCRIPTION OF DRAWINGS

FIG. 1 is a perspective view illustrating an entire stacker crane.

FIG. 2 is a side view illustrating the entire stacker crane.

FIG. 3 is a view illustrating a lifting section included in the stacker crane.

FIG. 4 is a perspective view illustrating a connection portion between a carriage and a raising and lowering wire.

FIG. 5 is a view illustrating an inside of a driver box.

FIG. 6 is a view illustrating an inside of a regeneration resistance box.

### DESCRIPTION OF EMBODIMENTS

The following description will discuss an embodiment of the present invention in detail.

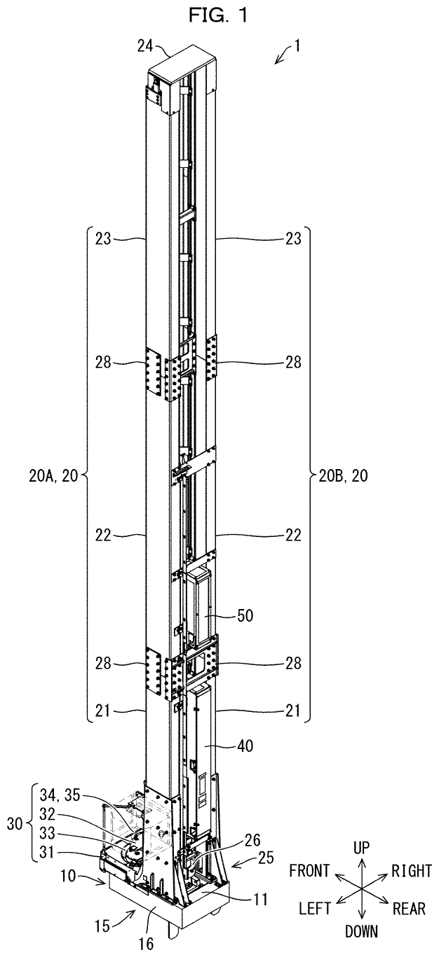

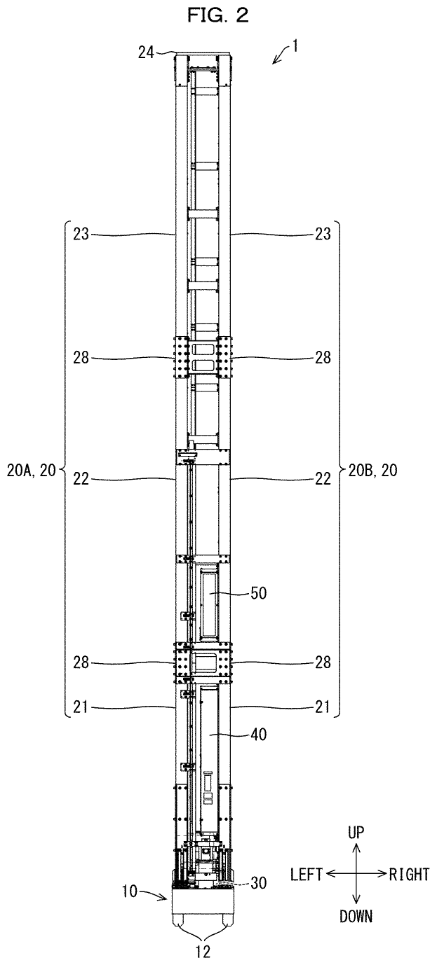

FIG. 1 is a perspective view illustrating an entire stacker crane 1. FIG. 2 is a side view illustrating the entire stacker crane 1. The stacker crane 1 includes a carrier section 10, masts 20, a carriage 30, a driver box 40, and a regeneration resistance box 50 (housing). In addition, the stacker crane 1 includes a control device (unillustrated) configured to control operations of the entire stacker crane 1. The control device is installed, for example, on a floor surface on which the stacker crane 1 is installed.

The carrier section 10 is a carrier that travels on a track. The track on which the carrier section 10 travels is located along a traveling guide rail (unillustrated) installed, for example, on the floor surface on which the stacker crane 1 is installed. The track may be located, for example, along a front-and-rear direction in FIG. 1 and the like. The carrier section 10 has a carrier frame 11 and a traveling motor unit 15. The masts 20 are provided upright on the carrier frame 11. In addition, wheels 12 for traveling on the traveling guide rail are provided under the carrier frame 11.

The traveling motor unit 15 is a driving section configured to cause the carrier section 10 to travel. The traveling motor unit 15 is provided in a lower part of the carrier frame 11. The traveling motor unit 15 has a traveling motor 16. Transmission of a driving force from the traveling motor 16 to the wheels 12 causes the wheels 12 to rotate. The rotation of the wheels 12 causes the stacker crane 1 to travel while being guided by the traveling guide rail.

The masts 20 are columnar members extending in an up-and-down direction. The stacker crane 1 includes the plurality of masts 20 that are adjacent to each other when seen in plan view from a direction perpendicular to the floor surface. For example, in FIG. 1, the stacker crane 1 includes the two masts 20. However, the stacker crane 1 may include three or more masts 20. In the following descriptions, the mast 20 on a left side of the drawing may be referred to as a first mast 20A, and the mast 20 on a right side of the drawing may be referred to as a second mast 20B.

The first mast 20A and the second mast 20B each have a first portion 21 and a second portion 22 disposed on the first portion 21 and coupled to the first portion 21. Therefore, compared to the case where the first mast 20A and the second mast 20B are each formed as a single member, the stacker crane 1 that has not been assembled can be downsized. This facilitates transportation of the stacker crane 1 that has not been assembled.

In addition, the first mast 20A and the second mast 20B each further have a third portion 23 disposed on the second portion 22 and coupled to the second portion 22. That is, the first mast 20A and the second mast 20B are each dividable into three portions. Therefore, compared to the case where the first mast 20A and the second mast 20B are each dividable into two portions, the stacker crane 1 that has not been assembled can be further downsized.

In addition, the first mast 20A and the second mast 20B may each have another member disposed on the third portion 23 and coupled to the third portion 23. In this case, the number of the other members may be one or may be two or more. That is, the first mast 20A and the second mast 20B may be each divided into four or more portions. Further, the first mast 20A and the second mast 20B may each have a coupling plate 28 for coupling the members to be coupled, among the first portion 21, the second portion 22, and the third portion 23.

The first mast 20A and the second mast 20B are spaced from each other in a right-and-left direction. The carriage 30 described later is provided so as to straddle the first mast 20A and the second mast 20B. The first mast 20A and the second mast 20B are each provided with a raising and lowering guide rail (unillustrated) for guiding the carriage 30 in the up-and-down direction.

An upper frame 24 is provided on the masts 20. The upper frame 24 is provided so as to connect an upper end part of the first mast 20A and an upper end part of the second mast 20B. The upper frame 24 is engaged with an upper guide rail (unillustrated) and guides, by the upper guide rail, the stacker crane 1.

The carriage 30 allows an article to be placed thereon and is provided so as to be capable of being raised and lowered with respect to the masts 20. The carriage 30 may include a carriage frame 31, a fork section 32 mounted in the carriage frame 31 and configured to transfer an article, and a turning section 33 configured to turn the fork section 32. Further, the carriage 30 may include a fork section control machine 34 configured to drive the fork section 32 and a turning section control machine 35 configured to drive the turning section 33. The fork section control machine 34 and the turning section control machine 35 may be provided, for example, on an oppose side of the carriage frame 31 to the masts 20.

### Lifting Section

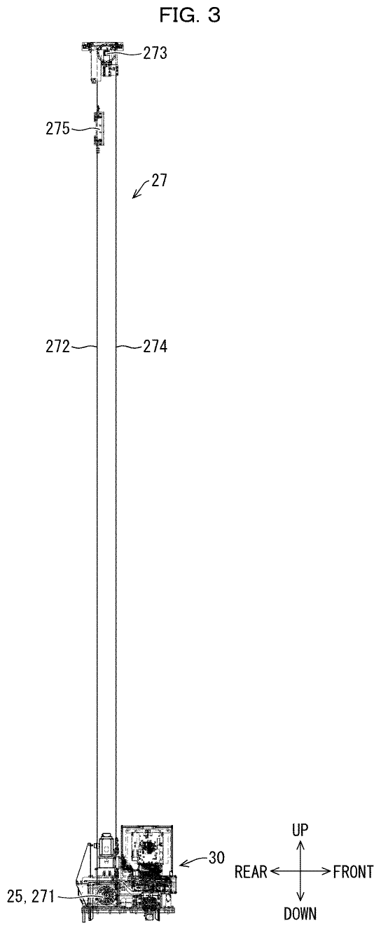

FIG. 3 is a view illustrating a lifting section 27 included in the stacker crane 1. The lifting section 27 is a mechanism configured to raise and lower the carriage 30 with respect to the masts 20. The lifting section 27 is provided to each of the first mast 20A and the second mast 20B. As illustrated in FIG. 3, the lifting section 27 includes a raising and lowering motor unit 25, a driving drum 271, raising and lowering wires 272 and 274, a pulley 273, and a counterweight 275.

The raising and lowering motor unit 25 is a driving section configured to raise and lower the carriage 30 with respect to the masts 20. The raising and lowering motor unit 25 is provided in lower parts of the masts 20. The raising and lowering motor unit 25 has a raising and lowering motor 26 configured to drive the driving drum 271 provided in the lower parts of the masts 20.

The raising and lowering wire 272 having one end fixed to a lower side of the carriage 30 is wound on the driving drum 271. The pulley 273 is provided on the masts 20. The raising and lowering wire 274 having one end fixed to an upper side of the carriage 30 is wound on the pulley 273. The other end of each raising and lowering wire 272 and 274 opposite to the one end fixed to the carriage 30 is fixed to the counterweight 275 that, when the carriage 30 moves, moves in a direction opposite to the movement direction of the carriage 30. That is, the carriage 30, the raising and lowering wire 272, the counterweight 275, and the raising and lowering wire 274 form a closed loop in the lifting section 27. The raising and lowering wires 272 and 274 are provided inside the masts 20.

In the lifting section 27, forward or backward rotation of the raising and lowering motor 26 causes the raising and lowering wire 272 to advance or retract with respect to the driving drum 271. The pulley 273 is rotated by advance and retraction of the raising and lowering wire 272. This causes the carriage 30 to be raised and lowered with respect to the masts 20.

### Belt Tension Adjustment Mechanism

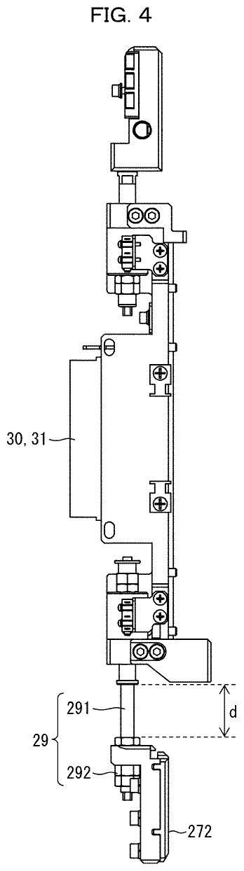

FIG. 4 is a perspective view illustrating a connection portion between the carriage 30 and the raising and lowering wire 272. For simplicity, FIG. 4 omits, from the carriage 30, the parts of the carriage frame 31 other than the vicinity of the connection portion with the raising and lowering wire 272. As illustrated in FIG. 4, the stacker crane 1 includes a tension adjustment mechanism 29 at the connection portion between the carriage 30 and the raising and lowering wire 272.

The tension adjustment mechanism 29 includes a bolt 291 and a double nut 292. The lower end of the carriage 30 and the upper end of the raising and lowering wire 272 are each provided with a hole into which the bolt 291 can be inserted. The bolt 291 is inserted from the carriage 30 toward the raising and lowering wire 272, and the double nut 292 is screwed to the tip end part of the bolt 291 inserted into the raising and lowering wire 272, so that the upper end of the raising and lowering wire 272 is connected to the lower end of the carriage 30.

Rotation of the double nut 292 with respect to the bolt 291 enables adjustment of a distance d between the lower end of the carriage 30 and the upper end of the raising and lowering wire 272. Therefore, the tension adjustment mechanism 29 makes it possible to adjust a tension of the raising and lowering wire 272 from a lower side of the carriage 30.

### Control Machine and Regeneration Resistor

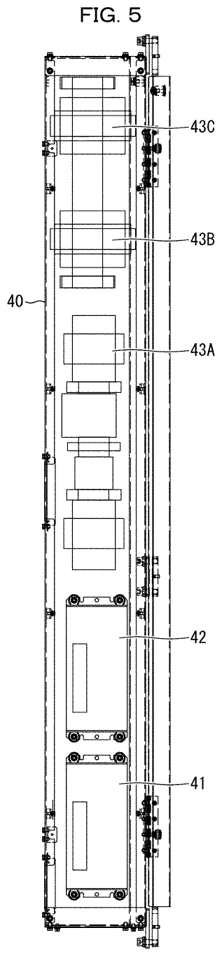

FIG. 5 is a view illustrating an inside of the driver box 40. As illustrated in FIG. 5, the driver box 40 accommodates a raising and lowering control machine 41 and a travel control machine 42. The driver box 40 may further accommodate breakers 43A, 43B, and 43C that interrupt the electrical connection between the raising and lowering control machine 41 and the raising and lowering motor 26 or between the travel control machine 42 and the traveling motor 16 as needed. The arrangement of the raising and lowering control machine 41, the travel control machine 42, and the breaker 43A inside the driver box 40 is not limited to the one illustrated in FIG. 5.

The raising and lowering control machine 41 is a control machine configured to drive the raising and lowering motor 26. The raising and lowering control machine 41 includes a driving circuit configured to supply electric current to the raising and lowering motor 26. The raising and lowering control machine 41 controls an amount of the electric current supplied to the raising and lowering motor 26 on the basis of a control signal from the unillustrated control device.

The travel control machine 42 is a control machine configured to drive the traveling motor 16. The travel control machine 42 includes a driving circuit configured to supply electric current to the traveling motor 16. The travel control machine 42 controls an amount of the electric current supplied to the traveling motor 16 on the basis of a control signal from the unillustrated control device.

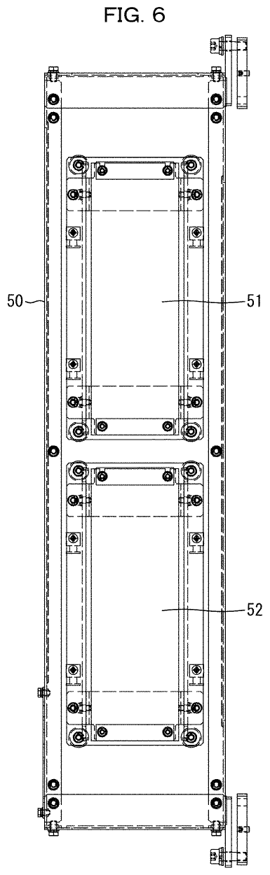

FIG. 6 is a view illustrating an inside of a regeneration resistance box 50. As illustrated in FIG. 6, the regeneration resistance box 50 accommodates a raising and lowering regeneration resistor 51 and a travel regeneration resistor 52. The arrangement of the raising and lowering regeneration resistor 51 and the travel regeneration resistor 52 inside the regeneration resistance box 50 is not limited to the one illustrated in FIG. 6.

The raising and lowering regeneration resistor 51 is a regeneration resistor configured to consume a regenerative energy caused when the raising and lowering motor 26 carries out regeneration operation. The travel regeneration resistor 52 is a regeneration resistor configured to consume a regenerative energy caused when the traveling motor 16 carries out regeneration operation. Specifically, the raising and lowering regeneration resistor 51 and the travel regeneration resistor 52 convert regenerative energy into heat. The raising and lowering regeneration resistor 51 is electrically connected to the raising and lowering motor 26 when the raising and lowering motor 26 carries out regeneration operation. The travel regeneration resistor 52 is electrically connected to the traveling motor 16 when the traveling motor 16 carries out regeneration operation.

In the stacker crane 1, the driver box 40 is fixed to the first portion 21 of the mast 20. Further, the regeneration resistance box 50 is fixed to the second portion 22 of the mast 20. That is, in the stacker crane 1, the raising and lowering control machine 41 and the travel control machine 42 are fixed to the first portion 21, and the raising and lowering regeneration resistor 51 and the travel regeneration resistor 52 are fixed to the second portion 22. Therefore, for example, compared to the case where the driver box 40 and the regeneration resistance box 50 are both fixed to the first portion 21, heat generated in the raising and lowering regeneration resistor 51 and the travel regeneration resistor 52 unlikely affects the raising and lowering control machine 41 and the travel control machine 42.

The heat generated in the raising and lowering regeneration resistor 51 and the travel regeneration resistor 52 increases the temperature of surrounding air. In general, air with an increased temperature is more likely to move upwards than downwards. That is, the heat, together with the air, is more likely to move upwards than downwards. Therefore, in the stacker crane 1, for example, compared to the case where the regeneration resistance box 50 is fixed to the first portion 21 and the driver box 40 is fixed to the second portion 22, the heat generated in the raising and lowering regeneration resistor 51 and the travel regeneration resistor 52 unlikely affects the raising and lowering control machine 41 and the travel control machine 42.

The traveling motor unit 15 and the raising and lowering motor unit 25 are located in a lower part of the stacker crane 1. Therefore, the fact that the driver box 40 is fixed to the first portion 21 facilitates electrically connecting the raising and lowering motor unit 25 and the raising and lowering control machine 41 and electrically connecting the traveling motor unit 15 and the travel control machine 42.

When each of the masts 20 is assembled, for example, only the first portion 21 may be first provided upright on the carrier frame 11. The second portion 22 and the third portion 23 may be then coupled to each other with the second portion 22 and the third portion 23 lying on the floor surface. Thereafter, the second portion 22 and the third portion 23 coupled to each other may be caused to stand upright and be coupled to the first portion 21 made stand upright on the carrier frame 11. This procedure makes it possible to assemble the masts 20 without high-place work. Such an assembly method can be used in a case where there is an insufficient work space to assemble the first portion 21, the second portion 22, and the third portion 23 while they are all lying, for example, in a case where the stacker crane 1 is assembled in a clean room.

In this case, the fact that the regeneration resistance box 50 is fixed to the second portion 22 enables the length of the first portion 21 itself to be shorten, compared to the case where the driver box 40 and the regeneration resistance box 50 are both fixed to the first portion 21. For example, the length of the first portion 21 can be not more than 3 meters. Therefore, a work of coupling the second portion 22 to an upper side of the first portion 21 made stand upright on the carrier frame 11 can be made no longer a high-place work. That is, it is possible to carry out a work of coupling the first portion 21 to the second portion 22 with use of a platform, without a vehicle for high-place work.

In addition, a worker works on the raising and lowering control machine 41 and the travel control machine 42 during maintenance of the stacker crane 1. The fact that the raising and lowering control machine 41 and the travel control machine 42 are fixed to the first portion 21 can make the work during the maintenance no longer a high-place work.

Further, the length of the first portion 21 may be shorter than the length of the second portion 22 and the length of the third portion 23. This decreases the height of the regeneration resistance box 50 fixed to the second portion 22, compared to the case where the length of the first portion 21 is equal to or larger than one or both of the length of the second portion 22 and the length of the third portion 23. Therefore, it is possible to improve workability also in a case where a worker works on the regeneration resistance box 50.

The driver box 40 and the regeneration resistance box 50 may be disposed between the first mast 20A and the second mast 20B. This enables the space between the first mast 20A and the second mast 20B to be used as a space in which the control machine and the regeneration resistor are to be installed. This makes the center of gravity of the stacker crane 1 closer to the center of the stacker crane 1 when the stacker crane 1 is seen in plan view from a direction perpendicular to the floor surface, resulting in improved stability of the stacker crane 1.

The driver box 40 and the regeneration resistance box 50 may be fixed to any of the plurality of masts 20. For example, in FIG. 1, the driver box 40 and the regeneration resistance box 50 are fixed to the first mast 20A. In this case, gaps are present between the driver box 40 and the regeneration resistance box 50, and the second mast 20B. This enables, for example, a raising and lowering cable for connecting the driver box 40 and the carriage 30 to be disposed in the gaps between the driver box 40 and the regeneration resistance box 50, and the second mast 20B. Therefore, it is possible to more easily connect the driver box 40 and the carriage 30 with use of the raising and lowering cable.

The regeneration resistance box 50 may have a vent causing an outside and an inside of the regeneration resistance box 50 to communicate with each other. For example, the regeneration resistance box 50 may be made from a metal plate provided with a punching hole serving as a vent. This enables air whose temperature has been raised by heat generated in the raising and lowering regeneration resistor 51 and the travel regeneration resistor 52 to be released from the vent to the outside of the regeneration resistance box 50. This improves the heat dissipation properties of the raising and lowering regeneration resistor 51 and the travel regeneration resistor 52.

As described above, the regeneration resistance box 50 is fixed to the second portion 22. This reduces the possibility of, for example, an accident in which a worker walking on the floor surface comes into contact with the regeneration resistor through the vent, compared to the case where the regeneration resistance box 50 is attached to the first portion 21.

### Variations

In the stacker crane 1, it is only necessary that at least one of the raising and lowering control machine 41 and the travel control machine 42 is fixed to the first portion 21. In other words, it is only necessary that a control machine configured to drive at least one of the raising and lowering motor 26 and the traveling motor 16 is fixed to the first portion 21. In the stacker crane 1, it is only necessary that at least one of the raising and lowering regeneration resistor 51 and the travel regeneration resistor 52 is fixed to the second portion 22. In other words, it is only necessary that a regeneration resistor configured to consume a regenerative energy caused when at least one of the raising and lowering motor 26 and the traveling motor 16 carries out regeneration operation is fixed to the second portion 22. According to the above configuration, heat generated in the regeneration resistor fixed to the second portion 22 unlikely affects the control machine fixed to the first portion 21.

Aspects of the present invention can also be expressed as follows:

A stacker crane in accordance with Aspect 1 of the present invention includes: a carrier section configured to travel on a track; a mast provided upright on the carrier section; a carriage provided so as to be capable of being raised and lowered with respect to the mast; a raising and lowering motor configured to raise and lower the carriage; a traveling motor configured to cause the carrier section to travel; a control machine configured to drive at least one of the raising and lowering motor and the traveling motor; and a regeneration resistor configured to consume regenerative energy caused when at least one of the raising and lowering motor and the traveling motor carries out regeneration operation, the mast having at least a first portion and a second portion disposed on the first portion and coupled to the first portion, the control machine being fixed to the first portion, the regeneration resistor being fixed to the second portion.

A stacker crane in accordance with Aspect 2 of the present invention is configured, in Aspect 1 above, to include a plurality of the masts disposed so as to be adjacent to each other when seen in plan view from a direction perpendicular to a floor surface, the control machine and the regeneration resistor being disposed between the plurality of the masts.

A stacker crane in accordance with Aspect 3 of the present invention is configured, in Aspect 2 above, such that the control machine and the regeneration resistor are, between the plurality of the masts, fixed to one of the plurality of the masts.

A stacker crane in accordance with Aspect 4 of the present invention is configured, in any one of Aspects 1 to 3 above, to further include a housing accommodating the regeneration resistor, the housing having a vent causing an outside of the housing and an inside of the housing to communicate with each other.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1 Stacker crane
10 Carrier section
16 Traveling motor
20, 20A, 20B Mast
21 First portion
22 Second portion
26 Raising and lowering motor
30 Carriage
41 Raising and lowering control machine (control machine)
42 Travel control machine (control machine)
50 Regeneration resistance box (housing)
51 Raising and lowering regeneration resistor (regeneration resistor)
52 Travel regeneration resistor (regeneration resistor)

1. A stacker crane comprising:
a carrier section configured to travel on a track;
a mast provided upright on the carrier section;
a carriage provided so as to be capable of being raised and lowered with respect to the mast;
a raising and lowering motor configured to raise and lower the carriage;
a traveling motor configured to cause the carrier section to travel;
a control machine configured to drive at least one of the raising and lowering motor and the traveling motor; and
a regeneration resistor configured to consume regenerative energy caused when at least one of the raising and lowering motor and the traveling motor carries out regeneration operation,
the mast having at least a first portion and a second portion disposed on the first portion and coupled to the first portion,
the control machine being fixed to the first portion,
the regeneration resistor being fixed to the second portion.

2. The stacker crane according to claim 1, comprising a plurality of the masts disposed so as to be adjacent to each other when seen in plan view from a direction perpendicular to a floor surface,
the control machine and the regeneration resistor being disposed between the plurality of the masts.

3. The stacker crane according to claim 2, wherein the control machine and the regeneration resistor are, between the plurality of the masts, fixed to one of the plurality of the masts.

4. The stacker crane according to claim 1, further comprising a housing accommodating the regeneration resistor,
the housing having a vent causing an outside of the housing and an inside of the housing to communicate with each other.
